(19) United States
(12) Patent Application Publication
(10) Pub. No.: US 2025/0196201 A1
(43) Pub. Date: Jun. 19, 2025

(54) METHOD OF LASER STIMULATION OF BARIUM AND/OR STRONTIUM COMPLEXION BY DTPA

(71) Applicant: PETRÓLEO BRASILEIRO S.A. - PETROBRAS, Rio de Janeiro (BR)

(72) Inventors: MARIO GERMINO FERREIRA DA SILVA, Rio de Janeiro (BR); FRANCISCA FERREIRA DO ROSÁRIO, Rio de Janeiro (BR)

(73) Assignee: PETRÓLEO BRASILEIRO S.A. - PETROBRAS, Rio de Janeiro, RJ (BR)

(21) Appl. No.: 18/982,965

(22) Filed: Dec. 16, 2024

(30) Foreign Application Priority Data
Dec. 14, 2023 (BR) 1320230263495

(51) Int. Cl. B08B 7/00; B08B 3/08; B08B 3/10; B08B 9/055; C09K 8/524; E21B 37/00

(52) U.S. Cl. CPC B08B 7/0042; B08B 3/08; B08B 3/10; B08B 9/055; C09K 8/524; E21B 37/00; B08B 2209/055

(57) ABSTRACT

The present invention relates to a Pig laser (10) that is equipped with a heating system to be used in the removal of scaling from subsea production systems (50) such as production lines, manifolds, ANMs and production columns. The induction promoted by the laser radiation is applied to the DTPA solution, heating and accelerating the reaction at the design limit temperature of the equipment to be descaling. At the same time, the laser is capable of maintaining the reaction temperature under control, considering the thermal demand of the reaction and the heat losses by the equipment that is located in ultra-deep waters, where the temperature is below 15° C. The target scaling is barium sulfate or strontium sulfate that are formed due to sulfated water coming from the reservoir that receives the injection of seawater without desulphation treatment. The present invention enables a method for descaling barium and strontium sulfate in the range of 60 to 100° C., with a pH preferably of 12.8, using DTPA composed in a 28.7% v/v solution and a mechanical agitation process.

### FIELD OF CERTIFICATE OF ADDITION OF INVENTION

The present invention falls within the field of technologies applicable in the areas of ensuring production flow, in the area of elevation and flow and in the management of scaling within reservoir management.

### DESCRIPTION OF THE STATE OF THE ART

Within the Oil industry, the Pig is a cylindrical or spherical device designed and initially used for the purpose of cleaning the inside of pipelines historically by pulling. It can be designed from a simple foam cylinder to even a more complex device such as a cylindrical metal structure (chassis), which uses a transverse disc as a guide and seal. The Pig is a device similar to a foam cylinder that moves through the inside of a pipeline driven by the fluid pressure of the pipeline itself.

Pigs are currently used both to clean and inspect the inside of the pipeline. In the latter case, they are known as instrumented pigs.

Pigging operations are part of a mandatory operational practice for preserving the internal condition of a pipeline, which aims to remove accumulations of deposits (such as paraffin and corrosion residues) and liquid phases (such as accumulated condensate) inside the pipeline, in addition to monitoring the conditions of the internal walls of the pipeline, for the occurrence of corrosive processes.

Pigging operations are performed by the action of objects called scrapers (pigs), which move inside the pipelines driven by a pressurized fluid, between pig launchers and receivers installed on the platform.

The inspection of the internal wall of the pipeline is performed by an instrumental pig, which is capable of measuring the extent and location of events such as corrosion residues, dents, ovalizations and bends. These operations are preceded by cleaning pigging to prepare the surface, allowing perfect access for the inspection pig along the entire length of the pipeline, in addition to avoiding the risk of entrapment due to the accumulation of residues that have not been removed.

The length of the pipeline to be inspected, the rate of deposit formation and the operational conditions will influence the choice of the type of pig to be used and the frequency of operations. Initially, the frequency of cleaning pigging operations can be once a month in the production collection system and once every 1.5 days for the flow system (export gas pipeline), while inspections with the instrumental pig will be carried out every 3 or 5 years.

Before the invention, the chemical scaling removal treatment was by pumping through the production lines and/or gas lift to the section of the line and/or equipment and leaving it for a while inside the line and/or equipment for the “chelation” reaction to occur and thus the scaling to be removed. However, given the problem of heat exchange with the seabed, during the pumping and movement of the chelating chemical product, through the gas lift line, from the production platform to the production line in the section where the scaling is, the pumped removal product cools due to the heat exchange between the lines and the seabed, and thus the yield of the scaling removal reaction had low efficiency depending on the temperature at which the treatment reached the production line in the range of interest to be treated.

The formation water found in most reservoirs has high concentrations of strontium (Sr²⁺) and calcium (Ca²⁺) ions, while the seawater used in well recovery has a high concentration of sulfate ions (SO₄²⁻). Thus, the mixture of these waters favors the formation of insoluble sulfates that are deposited, forming scales. In addition to sulfates, calcium carbonate (CaCO₃) scales can also occur due to the decay of reservoir pressure during oil production. Other types of deposits found are formed by ferrous sulfide (FeS) and ferrous hydroxide (Fe(OH)₂). According to Marques et al. (2001), the most common scales found in the producing wells of the Campos Basin are formed by strontium sulfates, with calcium carbonate scales being rare.

The technical problem encountered is that the temperature of the seabed in water depths of 700 meters or more remains around 4° C., and the underwater equipment used to transport oil production, such as the ANM wet Christmas tree, production lines and manifolds, are immersed in these temperature conditions. The heat exchange of this equipment on the seabed leads to the cooling of the produced fluids that are transported inside them.

Due to the distance between the satellite wells and the stationary production unit, there is a reduction in temperature that leads to the precipitation of components of the produced fluids, such as paraffins, asphaltenes and others, inside the equipment of the production system. Another type of precipitate that can occur inside the underwater production equipment is the scaling of barium sulfate and/or strontium sulfate in sandstone formations, and calcium carbonate in carbonate formations.

When salt scale build-up occurs inside the manifold, production loss may occur due to obstructions inside the manifold. The treatment to remove salt scale is carried out by pumping a chelating solution that is positioned inside the encrusted manifold where the complexation reactions of the cations in the salts occur and thus the scale is removed, thus unclogging the manifold.

The efficiency of the complexation reaction depends on the temperature. The optimum temperature range is around 80° C. However, due to heat exchange with the seabed, distances can sometimes reach 8 kilometers. Therefore, when the treatment is pumped, the temperature is reduced, reaching the manifold at a temperature below the ideal temperature for the complexation reaction.

The formation of scale in production wells and surface equipment is one of the main causes of increased operating costs and reduced oil production in oil wells (BEZERRA et al., 2013). These scales, accumulations of inorganic crystalline deposits, result from the precipitation of salts in the water of the reservoir or in the production system. The precipitation of these salts occurs when their solubility limit is reached, caused mainly by pH conditions, pressure, temperature or changes in water composition. However, predicting such a phenomenon is still a challenge, due to the complexity of precipitation kinetics.

The technical problem that motivated the invention certificate was the need to improve the dissolution yield of barium and strontium sulfate scales, when the scaling occurs in the submarine production system, mainly due to the low temperature of the seabed, especially in water depths above 700 m where the seawater is at a temperature of around 4 degrees Celsius.

The risks and difficulties associated with these were due to the low temperature of the seabed and the heat exchange of the fluids pumped inside the production system, that is, in the riser, production line, manifolds and underwater Christmas tree with the seabed environment, where above 700 m depth the seawater temperature is around 4° C., which promotes a reduction in the temperature of the pumped treatment, falling below the ideal range for good reaction performance, contributing to a reduction in the performance of the removal reaction, whose ideal temperature would be around 60° C., as this is the temperature limit to avoid generating structural problems in the production lines.

The formation of scale can involve, according to (MACKAY et al., 2004):
1) Decrease in pressure or increase in water temperature, leading to a reduction in salt solubility. The typical case is the reaction involving the equilibrium between bicarbonate and calcium ions, carbon dioxide gas and solid calcium carbonate:

Ca²⁺+2HCO³⁻<->CaCO₃+CO₂+H₂O (1)
2) Mixture of incompatible waters. Occurs when seawater mixes with formation water, leading to the precipitation of strontium and calcium sulfates.

Ba²⁺+SO₄²⁻->BaSO₄ (2)

Ca²⁺+SO₄²⁻->CaSO₄ (3)

Connate water+seawater->precipitation (4)
3) Evaporation of saline solutions, causing a reduction in solubility leading to the deposition of chlorides:

NaCl(aq)->NaCl(s) (5)

Thus, the occurrence of scaling in offshore fields is very common due to the incompatibility of the mixture of seawater with the formation water. Thus, when seawater injection begins into the reservoir, it mixes with the connate water (formation water). Since the waters generally have very different chemical compositions, scaling may begin due to the supersaturation of sparingly soluble salts, usually barium sulfate and strontium sulfate.

Associated with the occurrence of the facts mentioned above, production losses will be generated, with an impact on the economy of field production. To guarantee the maintenance of the productivity of the production system, it is necessary to inhibit deposition and/or remove the deposited material, such as strontium sulfate precipitate in offshore fields (THOMAS, 2001).

The document EP 2371923 A1 describes a process for inhibiting scaling in an underground oil or gas production formation, characterized by comprising the addition to the formation of a composition comprising a metal chelator, a scaling inhibitor and divalent metal cations, in which the stability constant of the metal chelator-metal cation chelate at room temperature is equal to or greater than the stability constant of the chelate formed from the metal cations and the scaling inhibitor, and in which the solubility of the chelate formed from the metal cations and the scaling inhibitor decreases with increasing temperature.

The document CN 113025295 A provides a low temperature plug release agent for oil and gas wells, which is made from raw materials with the following mass fractions: main agent DTPA 5 to 20%, auxiliary agent EDTA 1 to 3%, suspending agent 1 to 28, anionic emulsifier 1 to 3%, lubricant 0.5 to 18, the balance is water.

The document CA 3114487 A1 is directed to a composition for use in oil production operations, more specifically to compositions used in the removal of oil-contaminated barium sulfate scale. Accordingly, it discloses an aqueous composition for removing oil-contaminated barium sulfate scale from a surface contaminated with such, said composition comprising: —a chelating agent and a counterion component selected from the group consisting of: Li5DTPA; Na5DTPA; K5DTPA; Cs5DTPA; Na4EDTA; K4EDTA; TEAH4DTPA; and TBAH5DTPA; —a scale removal enhancer; —a non-ionic surfactant; and —a hydrotrope.

The document CN 106867490 A aims to solve the problem through a conventional scale removal enhancer agent where the compound has a complicated processing step, a long shutdown time, a secondary precipitation of the acidic liquid and a weak peeling effect. To this end, the present invention provides a chelating plugging agent suitable for use in complex scale reservoirs.

The above documents do not clearly disclose whether there are benefits to heating the chelating solution, or any type of heating device. The solution achieved by the present invention was the increase in the yield of the dissolution reaction of barium and strontium sulfate in DTPA with the application of laser induction at room temperature.

In this context, this certificate of addition of invention has the general objective of indicating the gains from the results of the study on the removal of barium and strontium sulfate scaling in offshore oil wells by complexation with a chelating agent promoted by an energy induction process. The study covered barium and strontium sulfate scaling, with particular attention being given to scales formed by barium and strontium sulfates given their very low solubility and difficulty in removal.

### BRIEF DESCRIPTION OF THIS CERTIFICATE OF ADDITION OF INVENTION

Aiming at the development of the application of laser technology in the management of scales to compensate for heat loss to the seabed, during pumping in scaling removal operations in the subsea production system in deep water depths, possibilities for the application of the technology were raised, which were planned to be applied in at least three distinct areas, from laboratory tests [1, 2], removal operations for offshore field application [3, 4, 5] and the installation of laser devices in production equipment to facilitate the maintenance of well production [6].

Thus, the scope of these tests performed aims to apply laser technology as a heating source, which was suggested due to its adaptability in terms of size reduction due to the level of compactness of laser diodes to develop equipment aimed at field application, given the advance in the size reduction of devices such as laser diodes in recent years, due to the evolution of nanotechnology, which allows obtaining power associated with the reduction in size of equipment.

The results obtained in the tests performed and shown in this certificate of addition prove that the application of laser radiation as a heat source can therefore be applied to laser equipment with higher power in Watts, aiming to obtain higher yields, mainly for production systems in more severe scaling environments. This certificate of invention provides the solution to the problems described above, through the application of laser induction for the complexation reactions of barium and strontium sulfate scaling inside the equipment of the subsea production system, where this technology will be used in association with other tools designed to operate in the different components of the subsea production system.

The experiments, which prove the increase in efficiency of the complexation reaction of barium sulfate and strontium sulfate by DTPA with laser induction, were carried out in a laboratory where a pulsed laser with a wavelength of 1064 nm and a power of 2 nano Joules per second was used. The tests performed demonstrate that even at room temperature, with the application of laser radiation there is an increase in the yield of the complexation reaction that leads to the dissolution of barium and strontium sulfates.

### BRIEF DESCRIPTION OF THE FIGURES

The present invention will be described in more detail below, with reference to the attached figures that, in a schematic manner and not limiting the inventive scope, represent examples of its implementation.

FIG. 1 illustrates a comparison with the dissolution of Barium with tests using Laser versus Control (without heating).

FIG. 2 shows the dissolved mass (g/L) during the dissolution of barium sulfate in DTPA. 5K solution, at temperatures of 4, 60 and 90° C., during 4 and 8 hours of testing.

### DETAILED DESCRIPTION OF THE CERTIFICATE OF ADDITION OF INVENTION

The present invention proposes a method of local laser induction in the deep water environment through the application of Laser radiation to promote the complexation reactions of strontium sulfate and barium sulfate with DTPA chelator. This solution will serve to remove these scales in deep and ultra-deep water scenarios, where the cooling of the underwater production lines is caused by the temperature of the seabed, and affects the reduction of the temperature of the fluids used in the removal of saline scales, negatively influencing the yield of the chemical reactions in the removal treatments through this chelator or others. For this purpose, Laser technology was chosen due to its size reduction capacity, and the heat generated by Laser radiation is applied to the reaction medium to photonically promote an increase in heat in the reaction.

Static test: In this test, on the mixture of 6 g of barium sulfate and 150 ml of DTPA in the beaker, laser radiation is applied to the solution inside the beaker to induce the Ba complexation reaction of BaSO₄. This induction process lasts about 4 hours. Samples are taken every hour for analysis in the MIPOES equipment, where the concentration of barium dissolved by DTPA will be determined every hour of the test.

Characteristics of the laser used:
Pulsed Nano Laser;
MAX OUTPUT: 600 mJ;
PULSE DURATION: 6 ns;
WAVELENGTH: 1064 nm;
LASER MEDIUM: Nd: YAG;

The characteristics of the Laser emitter (5) must be through Nd: YAG (neodymium-doped yttrium aluminum garnet) material, with maximum energy output around 600 mJ, with a pulse duration of 6 ns, and wavelength of 1064, 532.35 nm, with power of each pulse of 200 mJ/pulse; and means in the Pig Laser (10) to promote heating of the solution.

In a DTPA 40 solution at 28.7% v/v with laser thermal induction: On a semi-analytical balance, a mass of 6 grams of the investigated salt or of the mixture of salts is weighed, being 3 grams of BaSO₄+3 grams of SrSO₄ in a 300 ml polypropylene beaker, 150 ml of DTPA 40 at 28.7% is added, and the solution is homogenized. With thermal induction with radiation from the medium Nd: YAG laser with a power of 600 mJ on the solution inside the beaker with stirring by magnet at 600 rpm for 4 hours. Every 1 hour of testing, a 3 ml aliquot was removed with the 5 ml syringe and filtered with a MILEX filter; 0.45 μm pore into a 15 ml Falcon vial. Afterwards, 0.5 ml was removed with a pipette with a 0.5 ml tip from the Falcon vial. The dilutions were performed in two stages, the first being a 100-fold dilution, placing the 0.5 ml in a 50 ml Falcon vial with 49.5 ml of distilled water. And the second dilution of 40 times was carried out, removing with a pipette with a 0.5 ml tip the volume of 0.5 ml from the 1st Falcon bottle with 50 ml and placing it in a 2nd Falcon bottle with 19.5 ml of distilled water, totaling a dilution of 4000 times. The objective of this dilution was to protect the MIPOES equipment against the high salinity of the solution in order to avoid damage to it. Since the quantification of the concentration of ions (barium, strontium or the mixture) in the sample is done by the MIPOES technique, the wavelengths used for strontium were 407,771 nm mg/L, barium 455, 403 nm mg/L and potassium 766, 491 nm mg/L. The K analysis was used to monitor the dilution of the aliquots (×4000) removed from the dissolution reaction of the salts in relation to the DTPA 5K chelator.

Static test: In this test, on the mixture of 6 g of barium sulfate and 150 ml of DTPA in the beaker, laser radiation is applied to the solution inside the beaker to induce the complexation reaction of Ba and BaSO₄. This induction process lasts approximately 4 hours. Samples are taken every hour for analysis in the MIPOES equipment, where the concentration of barium dissolved by DTPA will be determined every hour of the test. Table 1 shows the test without the laser and Table 2 shows the test with the use of the laser.

TABLE 1
Control test without the laser
Control

| | | Temperature | |
|---|---|---|---|
| Sample | Time (min) | (Celsius) | Ba (mg/L) |
| T1 | 60 | 21.50 | 188 |
| T2 | 120 | 21.50 | 304 |
| T3 | 180 | 21.50 | 336 |
| T4 | 240 | 21.50 | 376 |

TABLE 2
Laser test
Laser test

| | | Temperature | |
|---|---|---|---|
| Sample | Time (min) | (Celsius) | Ba (mg/L) |
| T1 | 60 | 26. 6 | 320 |
| T2 | 120 | 27.5 | 408 |
| T3 | 180 | 28.0 | 484 |
| T4 | 240 | 27. 9 | 560 |

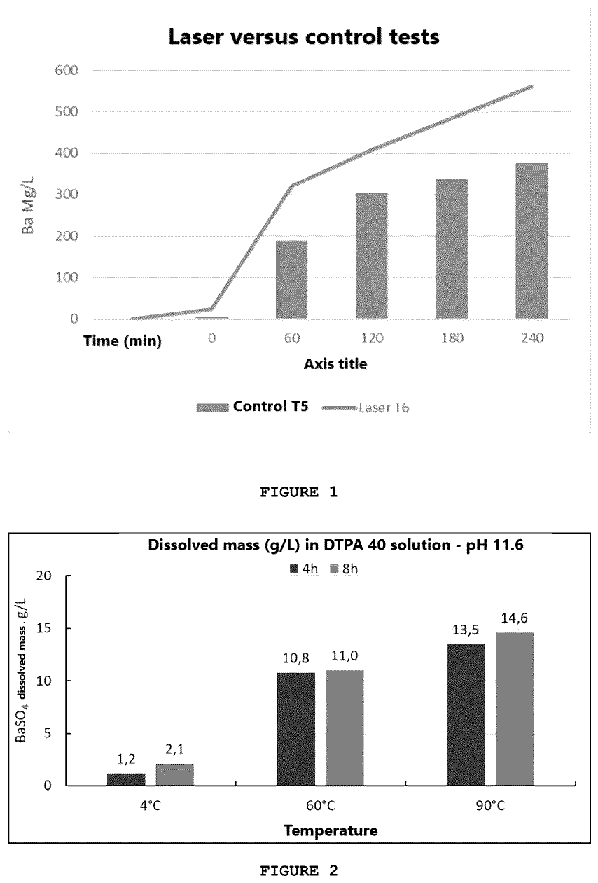

It can be seen in Table 3 and in the graph in FIG. 1 that the application of laser induction in the dissolution reactions of barium sulfate by complexation in static tests showed a significant increase in yield in relation to the control test, that is, compared to the dissolution test without the application of the laser. The yield is higher than 34% in the worst case.

TABLE 3
Comparison between Laser versus control tests
Comparison of laser induction versus control

| | | Control | Laser | | Laser |
|---|---|---|---|---|---|
| | Time | Ba | Ba | Difference | gain |
| Sample | (min) | (mg/L) | (mg/L) | (mg/L) | % |
| T1 | 60 | 188 | 320 | 132 | 70.21277 |
| T2 | 120 | 304 | 408 | 104 | 34.21053 |
| T3 | 180 | 336 | 484 | 148 | 44.04762 |
| T4 | 240 | 376 | 560 | 184 | 54.7619 |

FIG. 2 shows experimental results considering an increase in the efficiency of dissolving barium sulfate with increasing temperature. The contact time of 4 and 8 h between the remover solution and barium sulfate was not relevant, except for the temperature of 4° C., where the dissolved mass was double after 8 h of reaction (2.1 g/L) compared to the result obtained after 4 h (1.2 g/L) of testing. The literature indicates DTPA as the most efficient complexing agent for dissolving barium sulfate (Lakatos and Szabó, 2005; Jordan et al., 2012). It is possible to see that up to 4 h is the time required for the Barium to dissolve in the solution and make it saturated, and after that, waiting up to 8 h, although there is still dissolution, the rate is low and is not viable.

Therefore, considering the laboratory results, the invention comprises the use of a Pig laser (10) for generating thermal energy through Laser induction, where the application of Laser radiation generates heating of the DTPA solution preferably in the temperature range of 60 to 100° C., with pH preferably at 12.8, dissolving Barium Sulfate and/or Strontium Sulfate in DTPA solution, in which the solution is composed of distilled water and a concentration of 28.7% v/v of DTPA.

Therefore, it is possible to conclude that the application of laser induction compared to photonic induction performed by laser radiation promotes an increase in the yield of barium sulfate removal in the presence of DTPA.

The technical and economic advantages are associated with the reduction of the time of the rig and/or stimulation boats to perform the operations of removing saline scales that are normally used to perform the operations of removing barium and strontium sulfate scales in the wells and in the subsea production system. For example, if an operation with a boat costs around US$1,800,000.00 while with the rig having a daily rate ranging from US$153,000/day to US$264,000/day, and the mobilization of the rig to operate in a well takes around 4 to 5 days. The total cost would be US$1,000,000.00 and the reduction would be in 5 days.

### REFERENCES

The application of laser technology as a heating source was suggested due to its adaptability to develop equipment aimed at field application, given the advance in the reduction of the size of devices such as laser diodes in recent years, which allows obtaining power associated with the reduction of the size of the equipment.
[1] FERREIRA DA SILVA MARIO GERMINO [BR], LASER-ENERGIZED HEATING SYSTEM IN CARBONATE ROCK ACIDIFICATION TESTS. Applicants: PETROLEO BRASILEIRO SA PETROBRAS [BR]. Earliest priority: Nov. 6, 2020. Earliest publication: May 6, 2022, BR 102020022705 A2; CN 114441404 A; US2022146486 A1.
[2] GERMINO FERREIRA DA SILVA MARIO [BR]; ALVES FONTES ROSANE [BR]; FERREIRA DO ROSARIO FRANCISCA [BR]; SILVA ALVES DA ROSA KATIA REGINA [BR]; BATISTA ALVIM FELIPE [BR]. LASER RADIATION ARRANGEMENT FOR CATALYSIS IN COMPLEXATION REACTIONS. Applicants: PETROLEO BRASILEIRO SA PETROBRAS [BR]. Earliest priority: Nov. 29, 2019. Earliest publication: Jun. 3, 2021, AR 120569 A1; BR 102019025418 A2; BR 102019025418 B 1; CN 115087510 A; US2022410317 A1; WO 2021102544 A1.
[3] FERREIRA DA SILVA MARIO GERMINO [BR], FERREIRA DO ROSARIO FRANCISCA [BR], EQUIPMENT FOR LASER HEATING OF FLUIDS FOR INJECTION IN WELLS. Applicants: PETROLEO BRASILEIRO SA PETROBRAS [BR]. Earliest priority: Jul. 4, 2019, Earliest publication: Jan. 7, 2021, BR 102019013939 A2; CN 114364937 A; US2022356785 A1; WO 2021000034 A1.
[4] FRANCISCA FERREIRA DO ROSARIO [BR]; MARIO GERMINO FERREIRA DA SILVA [BR], LASER PIG FOR SCALE REMOVAL IN SUBSEA SYSTEMS. Assignee: PETROLEO BRASILEIRO SA PETROBRAS [BR]. Earliest priority: Dec. 10, 2019, Earliest publication: Jun. 22, 2021, BR 102019026153 A2.
[5] GERMINO FERREIRA DA SILVA MARIO [BR], LASER JETTER PIPE TOOL. Applicants: PETROLEO BRASILEIRO SA PETROBRAS [BR]. Earliest priority: Feb. 27, 2020, Earliest publication: Sep. 2, 2021, BR 102020003955 A2; CN 115551666 A; US2023111551 A1; WO 2021168524 A1.
[6] FERREIRA DA SILVA MARIO GERMINO [BR]. LASER MANDREL FOR REMOVAL OF SCALE IN PRODUCTION EQUIPMENT. Applicants: PETROLEO BRASILEIRO SA PETROBRAS [BR]. Earliest priority: Aug. 18, 2021. Earliest publication: Feb. 23, 2023, US2023059801 A1.

1. A method of laser stimulation of barium and/or strontium complexion by DTPA comprising a Pig laser for generating Laser, where the application of Laser radiation generates heating of the DTPA solution preferably in the temperature range 60 to 100° C., with pH preferably 12.8, dissolving Barium Sulfate and/or Strontium Sulfate in DTPA solution, in which the solution is composed of distilled water and a concentration of 28.7% v/v of DTPA; wherein the Laser emission has Nd: YAG (neodymium-doped yttrium aluminium garnet) material, with maximum energy output of approximately 600 mJ and may be 2000 mJ, with a pulse duration of 6 ns, and a wavelength of 1064,532,355 nm, with a power of each pulse of 200 to 600 mJ/pulse; and means in the Pig Laser to promote heating of the solution.

2. A method, according to claim 1, comprising the use of pig laser equipment for generating the laser, which is equipped with batteries, diodes, fiber optic cables, Collimators, temperature sensors, which are part of a minimum structure of the equipment for applying laser radiation.

3. A method, according to claim 1, wherein the laser generated at the end of a device is irradiated on the DTPA solution.
